(19) United States
(12) Patent Application Publication
(10) Pub. No.: US 2022/0271354 A1
(43) Pub. Date: Aug. 25, 2022

(54) Method and Arrangement for Operating a Battery Device

(71) Applicant: Vitesco Technologies GmbH, Regensburg (DE)

(72) Inventors: Markus Dietrich, München (DE); Philippe Grass, München (DE)

(73) Assignee: Vitesco Technologies GmbH, Regensburg (DE)

(21) Appl. No.: 17/629,579

(22) PCT Filed: Jul. 22, 2020
(86) PCT No.: PCT/EP2020/070684

§ 371 Date: Apr. 18, 2022

(30) Foreign Application Priority Data
Jul. 24, 2019 (DE) 10 2019 210 945.4

(51) Int. Cl. H01M 10/48; H01M 10/42; H01M 50/204; H01M 10/0525; H01M 10/633; H01M 10/651

(52) U.S. Cl. CPC H01M 10/482; H01M 10/425; H01M 50/204; H01M 10/0525; H01M 10/633; H01M 10/651; H01M 2010/4271

(57) ABSTRACT

Various embodiments of the teachings herein include a method for operating a battery device having a number of battery cells arranged in a battery housing. The method may include: detecting a fluid concentration of a predetermined fluid in an interior of the battery housing;

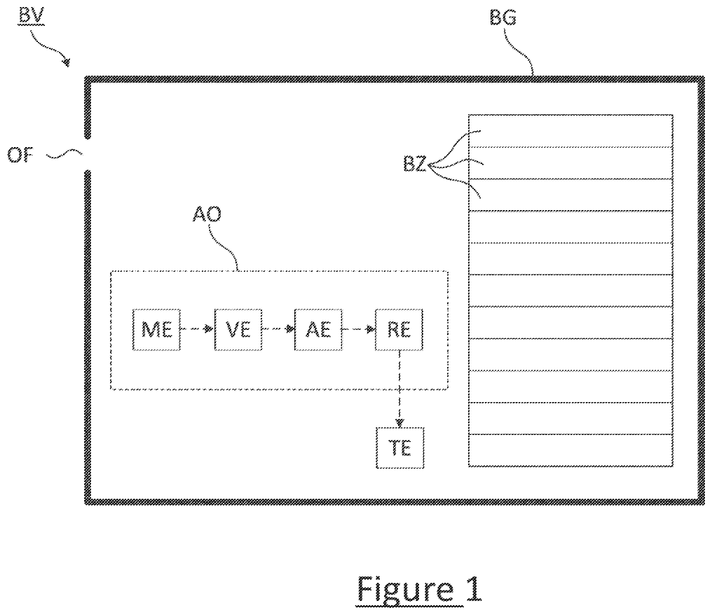

comparing the detected fluid concentration to a specified concentration threshold; adapting a maximum admissible operating temperature of the battery device if the detected fluid concentration exceeds the concentration threshold; and operating the battery device such that the maximum admissible operating temperature is not exceeded.

### CROSS-REFERENCE TO RELATED APPLICATIONS

This application is a U.S. National Stage Application of International Application No. PCT/EP2017/052654 filed Feb. 7, 2017, which designates the United States of America, and claims priority to DE Application No. 10 2016 202 540.6 filed Feb. 18, 2016, the contents of which are hereby incorporated by reference in their entirety.

### TECHNICAL FIELD

The present disclosure relates to energy storage devices. Various embodiments of the teachings herein include methods and arrangements for operating a battery device, in particular a traction battery device of an electrically driven vehicle. Background:

Lithium-ion battery cells or other battery cells with similar characteristics are used inter alia in battery devices, in particular in traction battery devices of electrically driven vehicles for the propulsion thereof. It is sought for the battery cells to be operated at the highest possible operating temperature, because the electrical conductivity of electrolytes in the battery cells increases with increasing operating temperature, whereby, in turn, the efficiency of the battery cells and thus that of the battery devices increases with the increasing battery temperature.

On the other hand, the thermal stability of some electrolytes, in particular some liquid electrolytes, in the battery cells rapidly decreases above a certain temperature, and the electrolytes begin to decompose above this temperature. This in turn leads to an uncontrollable failure of the battery cells. This certain temperature is generally referred to as the “battery-specific thermal stability limit”. Here, the thermal stability limit is dependent on numerous external and internal factors of the battery cells and changes over the service life of the battery cells. Consequently, the thermal stability limit cannot be determined or specified in advance.

As is customary in the case of many other technical devices, there is a general requirement in the case of battery devices for these to be operated as safely and efficiently as possible.

### SUMMARY

The teachings of the present disclosure may provide a possibility with which a battery device having a number of battery cells can be operated efficiently and as far as possible without failures in the battery cells. For example, some embodiments of the teachings herein include a method for operating a battery device (BV) having a number of battery cells (BZ) arranged in the interior of a battery housing (BG), including: detection of a fluid concentration of a predetermined fluid in the interior of the battery housing (BG); comparison of the detected fluid concentration with a specified concentration threshold; adaptation of a maximum admissible operating temperature of the battery device (BV) if the detected fluid concentration exceeds the concentration threshold; and operation of the battery device (BV) such that the maximum admissible operating temperature is not exceeded.

In some embodiments, the step of detection furthermore provides that a concentration of a predetermined gas is detected as the fluid concentration of the predetermined fluid.

In some embodiments, a concentration of the hydrogen, a concentration of the carbon dioxide, a concentration of the carbon monoxide or a concentration of a hydrocarbon is detected as the concentration of the predetermined gas.

In some embodiments, the step of comparison furthermore provides that the detected fluid concentration is compared with concentration thresholds of a predetermined operating temperature-concentration conversion table (lookup table) of the battery device (BV); and the step of adaptation furthermore provides that the maximum admissible operating temperature is adapted on the basis of the operating temperature-concentration conversion table and on the basis of the result of the comparison.

In some embodiments, the step of comparison furthermore provides that the detected fluid concentration is furthermore compared with a further specified critical concentration threshold; wherein a critical situation in the battery device (BV) is identified if the detected fluid concentration exceeds a further specified critical concentration threshold; and the step of operation furthermore provides that a fault message is output if the critical situation is identified.

In some embodiments, the steps of detection, of comparison and of adaptation are iteratively performed continuously or at specified time intervals over the service life of the battery device (BV).

In some embodiments, the step of operation furthermore provides that, by way of temperature control of the battery device (BV), the maximum admissible operating temperature is not exceeded.

In some embodiments, the step of operation furthermore provides that the battery device (BV) is operated at the maximum admissible operating temperature.

In some embodiments, the method furthermore includes detection of an air pressure in the interior of the battery housing (BG); wherein the step of adaptation further provides that the maximum admissible operating temperature is adapted on the basis of the detected air pressure.

As another example, some embodiments include an arrangement (AO) for operating a battery device (BV) having a number of battery cells (BZ) arranged in the interior of a battery housing (BG), comprising: a measurement unit (ME) for detecting a fluid concentration of a predetermined fluid in the interior of the battery housing (BG); a comparison unit (VE) for comparing the detected fluid concentration with a specified concentration threshold; an adaptation unit (AE) for adapting a maximum admissible operating temperature of the battery device (BV) if the detected fluid concentration exceeds the concentration threshold; and a closed-loop/open-loop control unit (RE) for operating the battery device (BV) such that the maximum admissible operating temperature is not exceeded.

As another example, some embodiments include a battery device (BV), comprising: a battery arrangement (BA) which has a battery housing (BG) and a number of battery cells (BZ), wherein the battery cells (BZ) are arranged in the interior of the battery housing (BG); and an arrangement (AO) as described herein for operating the battery device (BV).

### BRIEF DESCRIPTION OF THE DRAWINGS

An exemplary embodiment of the teachings herein is explained in greater detail below with reference to the accompanying drawing. Here, the single FIGURE shows, in a schematic illustration, a battery device BV with an arrangement AO for operating the battery device BV according to the exemplary embodiment.

### DETAILED DESCRIPTION

Some embodiments of the teachings of the present disclosure include a method for operating a battery device, in particular a traction battery device of an electrically driven vehicle, having a number of battery cells arranged in the interior of a battery housing of the battery device. In the methods, a (at least one) fluid concentration of a (at least one) predetermined fluid in the interior of the battery housing is (ongoingly or repeatedly) detected, in particular at or in the respective battery cells. Here, the fluid concentration may be measured at a location within the battery housing and outside the battery cells. The detected fluid concentration is then (ongoingly) compared with a (at least one) specified concentration threshold. If or as soon as the detected fluid concentration exceeds the concentration threshold, a maximum admissible operating temperature of the battery device is (dynamically) adapted or adjusted. The battery device is then (ongoingly) operated such that the maximum admissible operating temperature is not exceeded.

The fluid concentration of the predetermined fluid in the interior of the battery housing, in particular at or in the respective battery cells, is, in particular over the entire service life of the battery device, detected ongoingly continuously or repeatedly at specified regular intervals, and ongoingly compared with at least one or a number of specified concentration thresholds. If the detected fluid concentration exceeds the concentration threshold(s), the maximum admissible operating temperature of the battery device is dynamically adapted or adjusted. In the subsequent operating phase up until the next adaptation, the battery device is then ongoingly operated such that the maximum admissible operating temperature is not exceeded in this operating phase.

In some embodiments, a decomposition product of battery cell materials is selected as the predetermined fluid, the change in concentration of which is directly causally related to a battery cell state in which the (variable) battery-specific thermal stability limit of the battery cells is exceeded and in which the battery cell materials start to decompose. Based on the change in concentration of this fluid, a conclusion can thus be drawn that the (variable) battery-specific thermal stability limit has been exceeded. Through suitable selection of the fluid, signs of decomposition in the battery cells can be detected at an early stage. Accordingly, the battery cell temperature can be reduced in good time to the maximum admissible operating temperature or the dynamic thermal stability limit. If the maximum admissible operating temperature or the dynamic thermal stability limit is known, the battery device or the battery cells can be operated at the highest possible temperature that does not exceed the thermal stability limit.

The dynamic adaptation of the maximum admissible operating temperature on the basis of the (ongoingly or repeatedly) detected fluid concentration of the predetermined fluid and the subsequent operation of the battery device at or below the maximum admissible operating temperature until the next adaptation allows the battery device or the battery cells to be operated in a sparing and at the same time efficient manner over their entire service life. Further decomposition of the battery cell materials is thus prevented or limited to a minimal, non-hazardous level. Accordingly, temperature-induced failures in the battery cells are avoided, and the service life of the battery cell materials is consequently extended.

The battery device or the battery cells are operated at an operating temperature which is always (and in particular over the entire service life of the battery device or of the battery cells) and for example exactly at or around 1%, 2%, 5%, 8%, 10%, 15% or at most 20% below the maximum admissible, dynamically adapted operating temperature. In this way, the battery device or the battery cells are operated at the highest possible operating temperature without exceeding the battery-specific thermal stability limit. Consequently, a possibility is provided with which a battery device can be operated efficiently without significant temperature-induced failures.

The battery cells are for example configured as lithium-ion battery cells or other battery cells with similar characteristics. Accordingly, the battery device is for example configured as a lithium battery device. For example, a concentration of a predetermined gas that is one of the decomposition products of the electrolytes of the battery cells is detected as the fluid concentration of the predetermined fluid.

For example, a concentration of the hydrogen “H2”, a concentration of the carbon dioxide “CO2”, a concentration of the carbon monoxide “CO” or a concentration of a hydrocarbon is detected as the concentration of the predetermined gas. The gases mentioned are the decomposition products of the electrolytes of the battery cells. The increase in the concentration of these gases in the interior of the battery housing is an indicator that the maximum admissible operating temperature of the battery cells has been exceeded.

In some embodiments, the detected fluid concentration is compared with concentration thresholds of a predetermined operating temperature-concentration conversion table (lookup table) of the battery device. The maximum admissible operating temperature is then adapted on the basis of the operating temperature-concentration conversion table and on the basis of the comparison result. In this table, there are for example stored a multiplicity of previously determined maximum admissible operating temperatures for different life stages of the battery cells or for different state values (SOH values, “State of Health”) of the battery cells. Depending on the respectively present life stages or SOH values of the battery cells, a corresponding concentration threshold is then read from the table and compared with the presently detected fluid concentration.

In some embodiments, the detected fluid concentration is compared with a further specified critical concentration threshold. If and as soon as the detected fluid concentration exceeds the further critical concentration threshold, a critical situation in the battery device is identified. If a critical situation is identified, a fault message is output, for example in the form of a warning signal. Optionally, the battery device is deactivated in a controlled manner. With this measure, an impending risk of so-called thermal runaway in the battery cells is detected at an early point in time, and countermeasures, such as deactivation of the battery device, are initiated through the outputting of a fault message.

In some embodiments, the aforementioned steps of detection of the fluid concentration, comparison with the concentration threshold and adaptation of the maximum admissible operating temperature, and if appropriate also identification of the critical situation and output of a fault message, are iteratively performed continuously or ongoingly at specified time intervals over the, in particular entire, service life of the battery device.

In some embodiments, the battery device is temperature-controlled by cooling or heating such that the battery device is operated (slightly) below or (exactly) at the maximum admissible operating temperature. In particular, the battery device is operated exactly at or slightly below the maximum admissible operating temperature.

In some embodiments, in addition to the fluid concentration, an air pressure in the interior of the battery housing is also detected. In this case, the maximum admissible operating temperature is adapted also on the basis of the detected air pressure in addition to the fluid concentration. With the air pressure values, one of the main influential factors for the fluid concentration is also detected and taken into account in the adaptation. This increases the reliability of the adaptation.

In some embodiments, there is arrangement for operating a battery device, in particular a traction battery device of an electrically driven vehicle, having a number of battery cells arranged in the interior of a battery housing. The arrangement has a measuring unit that is configured to detect a fluid concentration of a predetermined fluid in the interior of the battery housing ongoingly continuously or regularly at specified time intervals. The arrangement furthermore has a comparison unit that is configured to continuously compare the fluid concentration detected by the measuring unit with a (at least one) specified concentration threshold. The arrangement furthermore has an adaptation unit that is configured to continuously dynamically adapt a maximum admissible operating temperature of the battery device if and as soon as the detected fluid concentration exceeds the concentration threshold. The arrangement furthermore has a closed-loop/open-loop control unit that is configured to operate the battery device until the next adjustment of the maximum admissible operating temperature such that the present maximum admissible operating temperature is not exceeded.

In some embodiments, there a battery device, in particular a traction battery device of an electrically driven vehicle. The battery device has a battery arrangement which has a battery housing and a number of battery cells, wherein the battery cells are arranged in the interior of the battery housing. The battery device furthermore has an above-described arrangement for operating the battery device.

Advantageous refinements of the above-described methods, insofar as they are otherwise transferable to the abovementioned arrangements or the abovementioned battery devices, are also to be regarded as advantageous refinements of the abovementioned arrangement or of the abovementioned battery device.

An exemplary embodiment of the invention is explained in greater detail below with reference to the accompanying drawing. Here, the single FIGURE shows, in a schematic illustration, a battery device BV with an arrangement AO for operating the battery device BV according to the exemplary embodiment of the invention.

The battery device BV, which in this embodiment is configured as a traction battery device of an electrically driven vehicle, has a battery housing BG and a battery pack made up of a multiplicity of battery cells BZ, which are arranged in the battery housing BG and are also protected against mechanical and other external influences by said battery housing. Lithium-ion battery cells, for example, are installed as the battery cells BZ.

Furthermore, the battery device BV has a temperature-control unit TE for controlling the temperature of, that is to say for cooling or heating, the battery device BV or the battery cells BZ. The temperature-control unit TE has, for example, a cooler with cooling channels for conducting a previously temperature-controlled cooling liquid, such as cooling water.

The battery housing BG has, for example on the housing wall, openings OF through which air or gases can flow from the interior of the battery housing BG into the surroundings of the battery housing BG and/or vice versa. The air pressure in the interior of the battery housing BG is equalized with the air pressure in the surroundings of the battery housing BG through the openings OF.

The efficiency of the battery device BV with the battery cells BZ increases with increasing battery cell temperature, because the conductivity of electrolytes used in the battery cells BZ increases with the increasing battery cell temperature, and consequently the internal resistance of the battery cells BZ decreases with the increasing battery cell temperature. Considered from this aspect alone, the battery device BV or the battery cells BZ should be operated at the highest possible battery cell or compartment temperature.

On the other hand, certain liquid electrolytes present in the battery cells BZ have a limited thermal stability and start to decompose above a certain (limit) temperature or a battery-specific thermal stability limit. As one of many decomposition products of this decomposition process, hydrogen is formed, which firstly accumulates in gaseous form in the interior of the battery housing BG and gradually escapes from the battery housing BG through the openings OF on the battery housing BG. This battery-specific thermal stability limit represents the maximum admissible operating temperature of the battery cells BZ or of the battery device BV and should not be exceeded.

This thermal stability limit is by no means a (limit) temperature that remains the same over the entire service life of the battery cells BZ, but changes constantly over the service life of the battery cells BZ owing to many internal and external influential factors of the battery cells BZ. If the battery cells BZ are operated at an operating temperature higher than the thermal stability limit, salts of the liquid electrolytes, in particular lithium salt, of the battery cells BZ react with one another in an uncontrollable manner. This leads to irreversible damage to the battery cells BZ and thus to rapid aging and even premature failure of these battery cells BZ. In order to counteract this, the battery cells BZ should be operated as continuously as possible over their entire service life at battery cell or compartment temperatures that are not higher than the dynamic thermal stability limit.

Furthermore, the least possible temperature control, that is to say cooling or warming, of the battery device BV or of the battery cells BZ should be performed, in order to avoid unnecessary energy costs. Since the power for temperature control is generally taken from the battery cells BZ themselves, unnecessary temperature control of the battery device BV leads to an unnecessary reduction in the amount of power of the battery device BV that can otherwise be effectively used.

In order to be able to operate the battery device BV optimally with regard to all three aspects mentioned above, the battery device BV has an arrangement AO for operating the battery device BV. The arrangement AO is for example configured as part of a battery management system of the battery device BV and has inter alia a measuring unit ME, a comparison unit VE, an adaptation unit AE and a closed-loop/open-loop control unit RE.

The measuring unit ME is configured to detect a fluid concentration of at least one predetermined fluid in the interior of the battery housing BG. Here, the measuring unit ME has, for example, a hydrogen sensor by means of which the measuring unit ME detects the concentration of hydrogen in the interior of the battery housing BG continuously, or ongoingly repeatedly at specified short time intervals of for example a few hundred milliseconds. The measuring unit ME transmits the measured values to the comparison unit VE, which from a signal transmission aspect is situated downstream of the measuring unit ME.

Although the hydrogen gradually escapes from the battery housing BG through the openings OF, the measuring unit ME can detect short-term increases in the hydrogen concentration in the interior of the battery housing BG with a high degree of accuracy owing to the short measuring period.

The comparison unit VE is configured to compare the detected fluid concentration with first, specified concentration thresholds, for example an operating temperature-concentration conversion table (lookup table). Here, the comparison unit VE has, for example, a comparator which compares the measurement data of the fluid concentration transmitted by the measurement unit ME with the first concentration thresholds and transmits comparison results to the downstream adaptation unit AE.

The adaptation unit AE is configured to dynamically adapt a maximum admissible operating temperature of the battery device BV or the battery cells BZ on the basis of the comparison results transmitted by the comparison unit VE, and to transmit the adapted maximum admissible operating temperature to the downstream closed-loop/open-loop control unit RE.

The closed-loop/open-loop control unit RE is configured to operate the battery device BV or to control the latter in open-loop and closed-loop fashion. In this case, the battery device BV operates at an operating temperature which is close to, in particular exactly at, but not above, the maximum admissible operating temperature. For this purpose, the closed-loop/open-loop control unit RE is configured to control the temperature-control unit TE in open-loop or closed-lead fashion on the basis of the maximum admissible operating temperature such that the temperature-control unit TE heats or cools the battery device BV or the battery cells BZ to the aforementioned operating temperature.

The arrangement AO optionally has an air-pressure measuring unit in the form of a first air pressure sensor, for example, which is configured to detect an air pressure, or a change in air pressure over time, in the interior of the battery housing BG and to transmit the detected pressure values to the downstream comparison unit VE. In this case, the lookup table contains pressure values as a further parameter. The comparison unit VE is accordingly configured to compare the measurement data of the fluid concentration transmitted by the measurement unit ME with the first concentration thresholds, taking into consideration the detected pressure values.

Following the description of the construction of the battery device BV together with the arrangement AO, its mode of operation, in particular that of the arrangement AO, will be described in detail below. To increase the efficiency and service life of the battery device BV or of the battery cells BZ, the measuring unit ME uses inter alia the hydrogen sensor to detect hydrogen concentration in the interior of the battery housing BG or at the battery cells BZ during active operation but also outside active operation (that is to say during the rest phase) of the battery device BV, ongoingly and regularly at specified time intervals. The measuring unit ME transmits the measured concentration values in the form of analog or digital measurement data to the downstream comparison unit VE.

The comparison unit VE uses inter alia the comparator to compare the concentration values transmitted by the measuring unit ME with specified concentration thresholds, for example from the abovementioned lookup table, and transmits the comparison results to the downstream adaptation unit AE.

The adaptation unit AE dynamically adapts a maximum admissible operating temperature of the battery device BV or the battery cells BZ inter alia on the basis of the comparison results transmitted by the comparison unit VE, and transmits the adapted maximum admissible operating temperature to the downstream closed-loop/open-loop control unit RE.

In the subsequent operating phase until the next adaptation, the closed-loop/open-loop control unit RE operates the temperature-control unit TE of the battery device BV such that it heats or cools the battery device BV or the battery cells BZ to an operating temperature which is exactly at the maximum admissible operating temperature or which is approximately 5% lower than the maximum admissible operating temperature. Here, the closed-loop/open-loop control unit RE continuously monitors the operating temperature of the battery device BV, such that the maximum admissible operating temperature is not exceeded (or is not exceeded for longer than a specified period of time).

Here, the maximum admissible operating temperature is preferably iteratively and dynamically adapted continuously, or ongoingly at the specified time intervals, over the entire service life of the battery device BV. For this purpose, the method steps described above, namely the detection of the hydrogen concentration, the comparison of the detected hydrogen concentration with the concentration thresholds and the dynamic adaptation of the maximum admissible operating temperature throughout the entire service life of the battery device BV, are iteratively performed continuously or ongoingly at the specified time intervals. In this way, the battery device BV or the battery cells BZ are always operated at the optimum operating temperature.

In some embodiments, an air pressure in the interior of the battery housing BG is also detected and used for the adaptation of the maximum admissible operating temperature.

In some embodiments, the comparison unit VE compares the detected hydrogen concentration values with a further specified critical concentration threshold. If or as soon as the critical concentration threshold is exceeded by the detected hydrogen concentration values, a critical situation, such as for example thermal runaway, is assumed to be present in the battery device BV or the battery cells BZ. In this case, the battery device BV is deactivated in a controlled manner and a fault message is output.

What is claimed is:

1. A method for operating a battery device having a number of battery cells arranged in a battery housing, having the method comprising:
detecting a fluid concentration of a predetermined fluid in an interior of the battery housing;
comparing the detected fluid concentration to a specified concentration threshold;
adapting a maximum admissible operating temperature of the battery device if the detected fluid concentration exceeds the concentration threshold; and
operating the battery device such that the maximum admissible operating temperature is not exceeded.

2. The method as claimed in claim 1, wherein detecting the fluid comprises a gas.

3. The method as claimed in claim 2, wherein the gas includes at least one gas selected from the group consisting of: hydrogen, carbon dioxide, carbon monoxide, and a hydrocarbon.

4. The method as claimed in claim 1, wherein:
comparing the detected fluid concentration to a specified concentration threshold includes using
a predetermined operating temperature-concentration conversion table (lookup table) of the battery device; and
adapting the maximum admissible operating temperature is based at least in part on the operating temperature-concentration conversion table and the comparison.

5. The method as claimed in claim 1, wherein:
comparing the detected fluid concentration to a specified concentration threshold includes comparing the detected fluid concentration with a further specified critical concentration threshold;
the method further comprising identifying a critical situation in the battery device if the detected fluid concentration exceeds a further specified critical concentration threshold; and
obtaining the battery device include generating a fault message if the critical situation is identified.

6. The method as claimed in claim 1, wherein detecting, comparing, and adapting are iteratively performed continuously or at specified time intervals over a service life of the battery device.

7. The method as claimed in claim 1, wherein operating the battery device includes ensuring the maximum admissible operating temperature is not exceeded.

8. The method as claimed in claim 1, wherein operating the battery device includes operating the battery device at the maximum admissible operating temperature.

9. The method as claimed in claim 1, furthermore comprising
detecting an air pressure in the interior of the battery housing;
wherein adapting the maximum admissible operating temperature depends at least in part on the detected air pressure.

10. An arrangement for operating a battery device having a number of battery cells arranged in a battery housing, the arrangement comprising:
a meter for detecting a fluid concentration of a predetermined fluid in an interior of the battery housing;
a processor for comparing the detected fluid concentration with a specified concentration threshold;
an adaptation unit for adapting a maximum admissible operating temperature of the battery device if the detected fluid concentration exceeds the concentration threshold; and
a control unit for operating the battery device such that the maximum admissible operating temperature is not exceeded.

11. A battery device comprising:
a battery arrangement with a battery housing and a number of battery cells arranged in an interior of the battery housing;
a meter for detecting a fluid concentration of a predetermined fluid in an interior of the battery housing;
a processor for comparing the defected fluid concentration with a specified concentration threshold;
an adaptation unit for adapting a maximum admissible operating temperature of the battery device if the detected fluid concentration exceeds the concentration threshold; and
a control unit for operating the battery device such that the maximum admissible operating temperature is not exceeded.
